(19) United States
(12) Patent Application Publication
(10) Pub. No.: US 2018/0242811 A1
(43) Pub. Date: Aug. 30, 2018

(54) GRILL CLEANING DEVICE AND METHOD

(71) Applicant: Kirk Staresinic, Lancaster, CA (US)

(72) Inventor: Kirk Staresinic, Lancaster, CA (US)

(21) Appl. No.: 15/905,793

(22) Filed: Feb. 26, 2018

Related U.S. Application Data
(60) Provisional application No. 62/463,566, filed on Feb. 24, 2017.

(51) Int. Cl. A47L 13/34; A47L 13/022; A47J 37/07

(52) U.S. Cl. CPC A47L 13/34; A47J 37/0786; A47L 13/022

(57) ABSTRACT

A grill cleaning device includes an elongated shaft having a proximate end and a distal end along with a plurality of grill-cleaning attachments. The elongated shaft also features a handle grip located at the proximate end and a female clip portion located at the distal end. Each one of the plurality of grill-cleaning attachments includes a working surface and a male clip portion configured to mechanically couple with the female clip portion of the elongated shaft. The elongated shaft and the grill-cleaning attachments are configured for selective replacement and interchangeability as desired by a user to clean and prepare a grilling surface.

### CROSS-REFERENCE TO RELATED APPLICATION(S)

The present application is related to and claims priority to U.S. Provisional Patent Application No. 62/463,566 filed Feb. 24, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of cleaning tools of existing art and more specifically relates to multi-purpose tools.

### RELATED ART

Cleaning and maintaining a grill can be a frustrating experience. Multiple tools are often needed, such as a wire brush, cleaning brush, and the like. These tools can be difficult to store near a grill and may be at risk for falling onto the ground. Having to keep track of numerous grilling tools can be difficult, and if a cleaning brush is lost, people may completely abandon cleaning their grill each time it is used. A suitable solution is desired.

U.S. Pat. No. 8,438,687 to Eric R. Cybulski, et al., relates to a heated food preparation surface cleaning system. The described heated food preparation surface cleaning system includes a cleaning tool including a handle and a detachable base. The handle and detachable base comprise a polymeric material, where the melting point of the polymeric material in the handle is lower than the melting point of the polymeric material in the base. The system includes a scrubbing pad support member that is configured to engage and secure a scrubbing pad and connect the scrubbing pad to a handle or a base of a cleaning tool. The handle of the tool is constructed to be reused numerous times whereas the detachable accessories, e.g., the scrubbing pad support member and/or a scrubbing pad, are disposable. A method of molding the scrubbing pad support member is also provided.

### SUMMARY OF THE INVENTION

In view of the foregoing disadvantages inherent in the known cleaning tools art, the present disclosure provides a novel grill cleaning device and method. The general purpose of the present disclosure, which will be described subsequently in greater detail, is to provide a multipurpose tool including a plurality of interchangeable attachments suited for cleaning and preparing a heated cooking surface.

A grill cleaning device is disclosed herein. The grill cleaning device may include an elongated shaft having a proximate end and a distal end along with a plurality of grill-cleaning attachments. The elongated shaft may also feature a handle grip located at the proximate end and a female clip portion located at the distal end. Each one of the plurality of grill-cleaning attachments may include a working surface and a male clip portion configured to mechanically couple with the female clip portion of the elongated shaft. The elongated shaft and the grill-cleaning attachments may be configured for selective replacement and interchangeability as desired by a user. Male and female connections may be reversed.

According to another embodiment, a method of using a grill cleaning device is also disclosed herein. The method of using a grill cleaning device may include providing a grill cleaning device including an elongated shaft having a proximate end and a distal end, the elongated shaft including a handle grip located at the proximate end and a female clip portion located at the distal end and a plurality of grill-cleaning attachments, each of the plurality of grill-cleaning attachments including a working surface and a male clip portion configured to mechanically couple with the female clip portion of the elongated shaft, selecting one of the plurality of grill-cleaning attachments for use, coupling the male clip portion of one of the plurality of grill-cleaning attachments into the female clip portion of the elongated shaft, and cleaning the barbecue grill cooking surface.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a grill cleaning device and method, constructed and operative according to the teachings of the present disclosure.

FIG. 1 is a perspective view of the grill cleaning device during an ‘in-use’ condition, according to an embodiment of the disclosure.

FIG. 2 is a perspective view of the grill cleaning device of FIG. 1, according to an embodiment of the present disclosure.

FIG. 3 is an additional perspective view of the grill cleaning device of FIG. 1, according to an embodiment of the present disclosure.

FIG. 4 is a perspective view of the grill cleaning device of FIG. 1, according to an embodiment of the present disclosure.

FIG. 5 is a flow diagram illustrating a method of using a grill cleaning device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a cleaning tool and more particularly to a grill cleaning device as used to provide a multipurpose tool including a plurality of interchangeable attachments suited for cleaning and preparing a heated cooking surface.

Many people enjoy cooking on a barbecue grill. A barbecue grill is a device that cooks food by applying heat from below. There are several varieties of grills, with most falling into one of two categories: gas-fueled or charcoal. Gas-fueled grills typically use propane or natural gas as their fuel source, with gas-flame either cooking food directly or heating grilling elements that in turn radiate the heat necessary to cook food.

Generally, the grill cleaning device of this disclosure may provide grill owners with a multipurpose tool capable of functioning as a wire brush, spatula, large fork, and more. The device may feature a clipping mechanism on one end of the handle, capable of receiving the multiple tool heads. It may also include a rubber gripping handle at the opposite end to ensure users have a firm grip on the brush while it is being used to clean the grill or tend to food. The device may be helpful for keeping multiple tools in one convenient place, thereby saving extensive amounts of space on and near the grill. The present invention may offer a more sanitary method for cleaning barbeque grill surfaces for both amateur and professional grillers.

The grill cleaning device may be configured to allow a user to choose an attachment and clip the head portion to the handle. The individual can then utilize the grilling tool as needed in order to service the grill or handle food. Each attachment may be easily attached and detached for both use and cleaning purposes. The device can be constructed using plastic and other suitable materials. The device may also be available in various sizes, all suited to accommodate user needs and preferences. Exact size, measurement, construction, and design specifications may vary upon manufacturing.

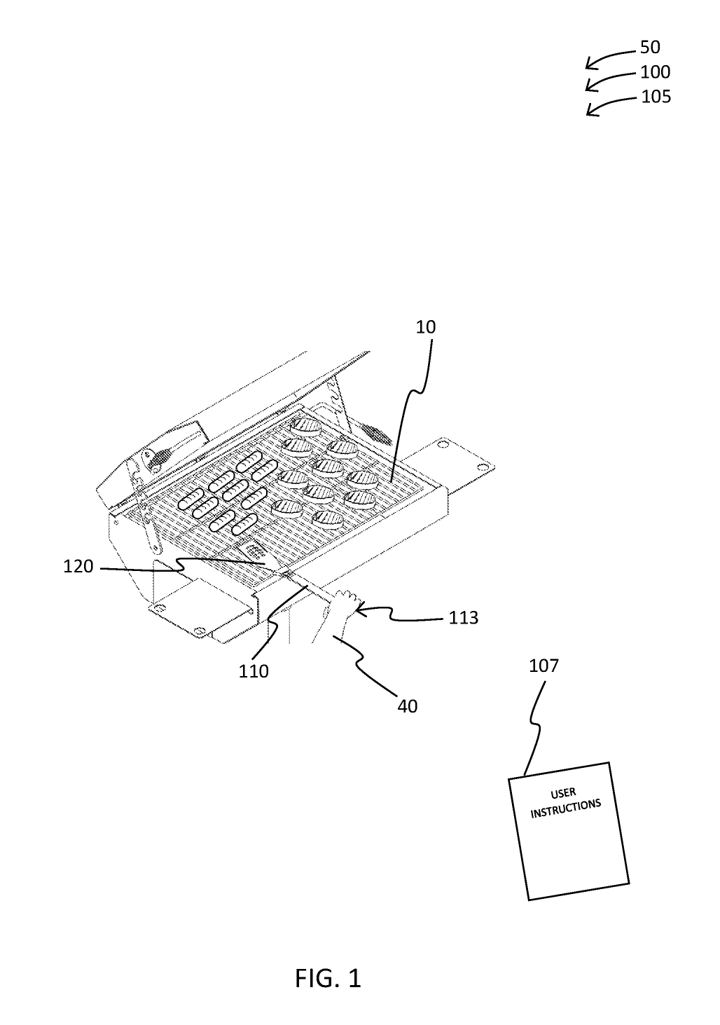

Referring now more specifically to the drawings by numerals of reference, there is shown in FIGS. 1-4, various views of a grill cleaning device 100.

FIG. 1 shows a grill cleaning device 100 during an ‘in-use’ condition 50, according to an embodiment of the present disclosure. Here, the grill cleaning device 100 may be beneficial for use by a user 40 to provide a multipurpose tool including a plurality of interchangeable attachments suited for cleaning and preparing a heated cooking surface. As illustrated, the grill cleaning device 100 for use in cleaning a barbecue grill cooking surface 10 may include an elongated shaft 110 having a handle grip 113, wherein the elongated shaft 110 may be configured for removable connection with a plurality of grill-cleaning attachments 120.

According to one embodiment, the grill cleaning device 100 may be arranged as a kit 105. In particular, the grill cleaning device 100 may further include a set of instructions 107. The instructions 107 may detail functional relationships in relation to the structure of the grill cleaning device 100 such that the grill cleaning device 100 can be used, maintained, or the like, in a preferred manner.

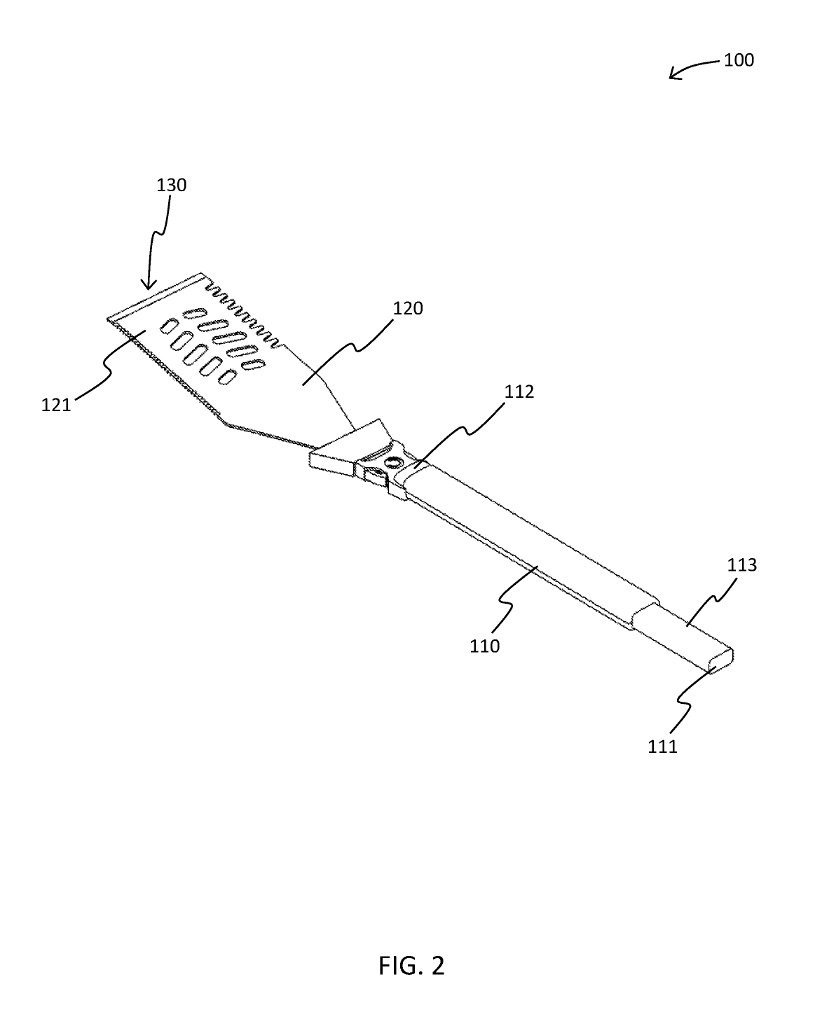

FIG. 2 shows the grill cleaning device 100 of FIG. 1, according to an embodiment of the present disclosure. As above, the grill cleaning device 100 may include an elongated shaft 110 having a proximate end 111 and a distal end 112. The elongated shaft 110 may further include a handle grip 113 located at the proximate end 111. The grill cleaning device 100 may also feature a plurality of grill-cleaning attachments 120, with each of the plurality of grill-cleaning attachments 120 including a working surface 121. In the present embodiment, the working surface 121 may also include a beveled edge 130 suited for wedging force against food items or scraping away grill residue.

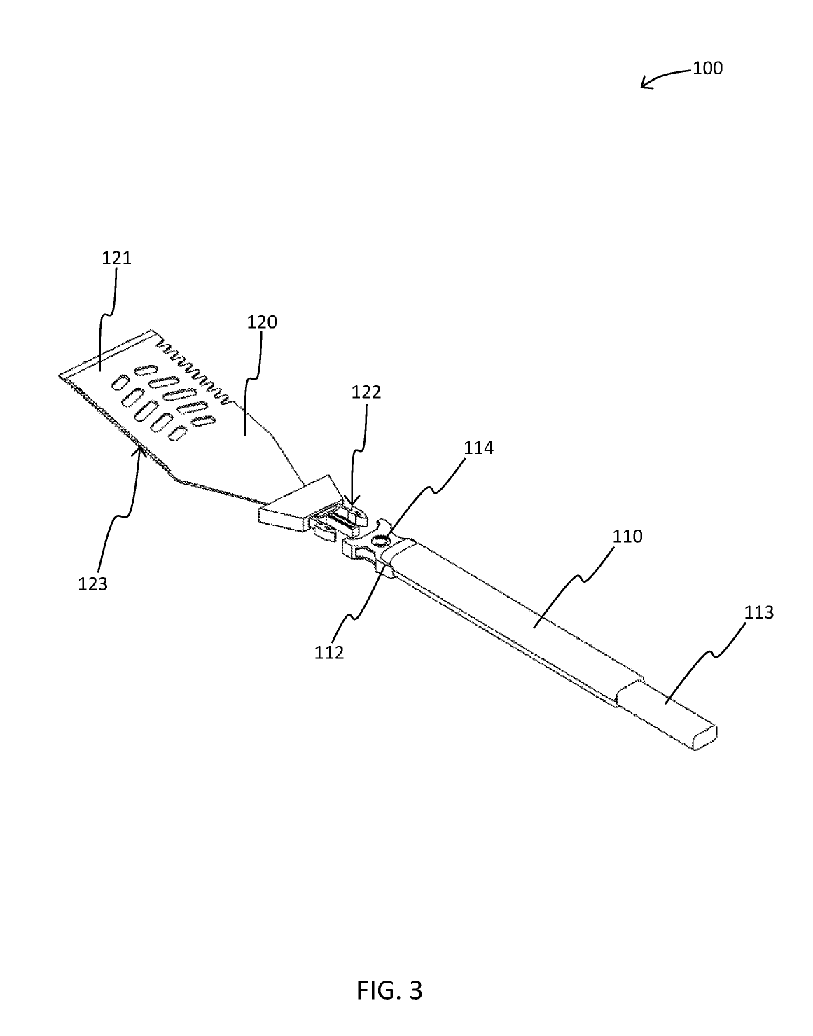

Referring now to FIG. 3 showing a perspective view of the grill cleaning device 100 of FIG. 1, according to an embodiment of the present disclosure. Here again, the grill cleaning device 100 may include an elongated shaft 110 having a handle grip 113 and a female clip portion 114 located at the distal end 112 of the grill cleaning device 100. In addition, the grill cleaning device 100 may also include a plurality of grill-cleaning attachments 120, wherein each of the plurality of grill-cleaning attachments 120 may include a working surface 121 and a male clip portion 122 configured to mechanically couple with the female clip portion 114 of the elongated shaft 110. In the present embodiment, the grill cleaning device 100 may also feature a second working surface 123 for performing supplementary cleaning tasks.

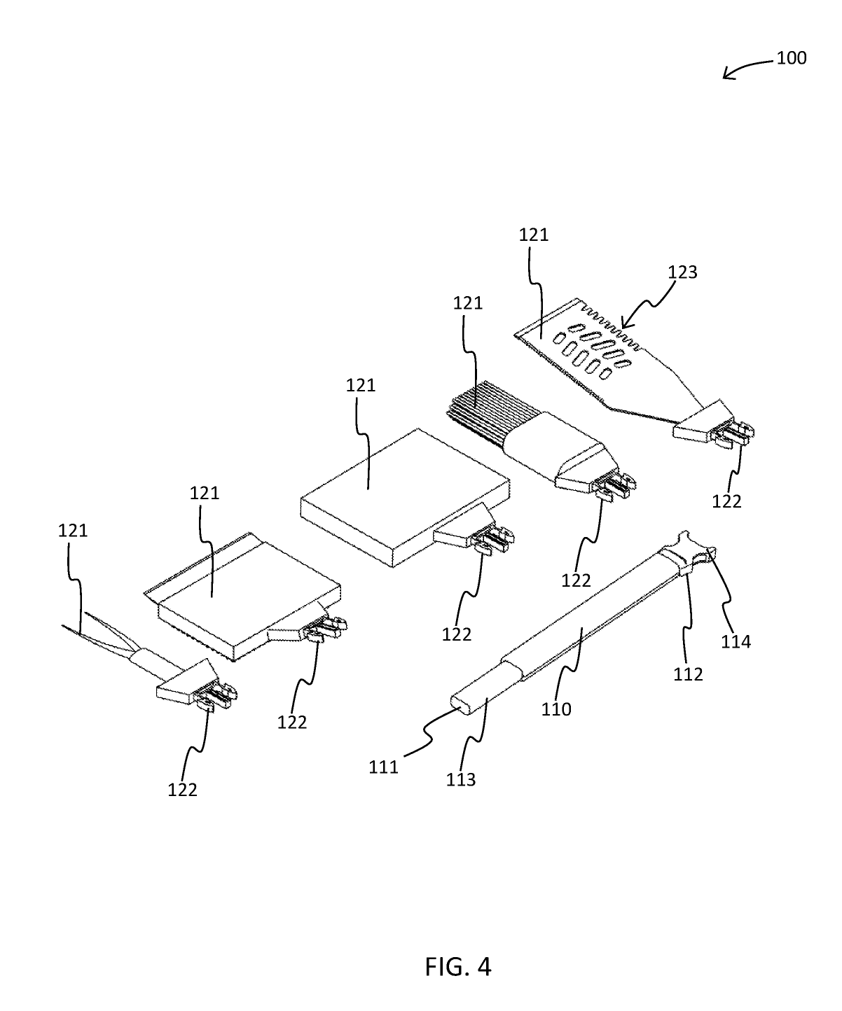

FIG. 4 is a perspective view of the grill cleaning device 100 of FIG. 1, according to an embodiment of the present disclosure. As above, the grill cleaning device 100 may include an elongated shaft 110 having a proximate end 111 and a distal end 112. The elongated shaft 110 may itself include a handle grip 113 located at the proximate end 111 and a female clip portion 114 located at the distal end 112. The female clip portion 114 located at the distal end 112 of the elongated shaft 110 may be configured to removably couple with the male clip portion 122 of each one of the plurality of grill-cleaning attachments 120 (see FIG. 2). Here again, each one of the plurality of grill-cleaning attachments 120 (see FIG. 2) may include a working surface 121 and/or a second working surface 123.

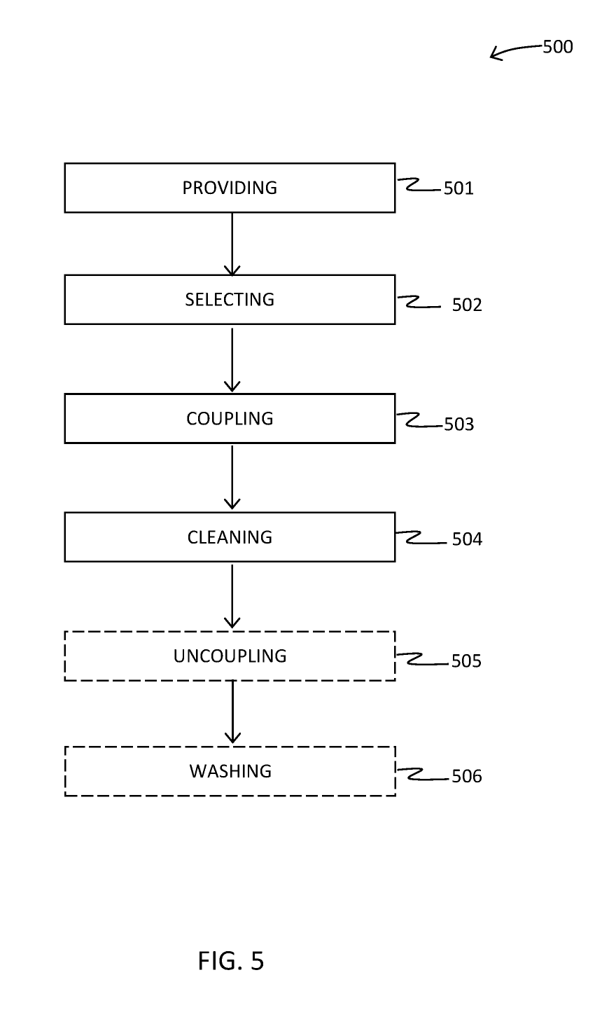

FIG. 5 is a flow diagram illustrating a method of using 500 a grill cleaning device 100, according to an embodiment of the present disclosure. In particular, the method of using 500 a grill cleaning device 100 may include one or more components or features of the grill cleaning device 100 as described above. As illustrated, the method of using 500 a grill cleaning device 100 may include the steps of: step one 501, providing a grill cleaning device 100 including an elongated shaft 110 having a proximate end 111 and a distal end 112, the elongated shaft 110 including a handle grip 113 located at the proximate end 111 and a female clip portion 114 located at the distal end 112 and a plurality of grill-cleaning attachments 120, each of the plurality of grill-cleaning attachments 120 including a working surface 121 and a male clip portion 122 configured to mechanically couple with the female clip portion 114 of the elongated shaft 110; step two 502, selecting one of the plurality of grill-cleaning attachments 120 for use; step three 503, coupling the male clip portion 122 of one of the plurality of grill-cleaning attachments 120 into the female clip portion 114 of the elongated shaft 110; and step four 504, cleaning the barbecue grill cooking surface 10.

It should be noted that steps 505 and 506 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for grill cleaning device 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A grill cleaning device for use in cleaning a barbecue grill cooking surface, the device comprising:
an elongated shaft having a proximate end and a distal end, the elongated shaft including a handle grip located at the proximate end and a female clip portion located at the distal end; and
a plurality of grill-cleaning attachments, each of the plurality of grill-cleaning attachments including a working surface and a male clip portion configured to mechanically couple with the female clip portion of the elongated shaft;
wherein the working surface of each of the plurality of grill-cleaning attachments is structurally distinct; and
wherein the plurality of grill-cleaning attachments is configured for selective replacement as desired by a user.

2. The grill cleaning device of claim 1, wherein the plurality of grill-cleaning attachments further includes a second working surface.

3. The grill cleaning device of claim 2, wherein the second working surface is on an opposite side of the working surface.

4. The grill cleaning device of claim 1, wherein the elongated shaft comprises polyurethane.

5. The grill cleaning device of claim 1, wherein the female clip portion and male clip portion comprise polyurethane.

6. The grill cleaning device of claim 1, wherein the plurality of grill-cleaning attachments includes a spatula.

7. The grill cleaning device of claim 6, wherein the spatula includes a beveled edge.

8. The grill cleaning device of claim 6, wherein the spatula comprises metal.

9. The grill cleaning device of claim 1, wherein one of the plurality of grill-cleaning attachments includes a wire brush.

10. The grill cleaning device of claim 1, wherein one of the plurality of grill-cleaning attachments includes a cleaning pad.

11. The grill cleaning device of claim 1, wherein one of the plurality of grill-cleaning attachments includes a fork.

12. The grill cleaning device of claim 11, wherein the fork comprises metal.

13. The grill cleaning device of claim 11, wherein the fork includes a pair of skewer-prongs.

14. The grill cleaning device of claim 1, wherein the handle grip comprises rubber.

15. The grill cleaning device of claim 1, wherein the elongated shaft is at least 4 inches in length.

16. The grill cleaning device of claim 1, wherein the device weighs less than 5 lbs.

17. A grill cleaning device for use in cleaning a barbecue grill cooking surface, the device comprising:
an elongated shaft having a proximate end and a distal end, the elongated shaft including a handle grip located at the proximate end and a female clip portion located at the distal end; and
a plurality of grill-cleaning attachments, each of the plurality of grill-cleaning attachments including a working surface and a male clip portion configured to mechanically couple with the female clip portion of the elongated shaft;
wherein the working surface of each of the plurality of grill-cleaning attachments is structurally distinct;
wherein the plurality of grill-cleaning attachments is configured for selective replacement as desired by a user;
wherein the plurality of grill-cleaning attachments further includes a second working surface;
wherein the second working surface is on an opposite side of the working surface;
wherein the elongated shaft comprises polyurethane;
wherein the female clip portion and male clip portion comprise polyurethane;
wherein the plurality of grill-cleaning attachments includes a spatula;
wherein the spatula includes a beveled edge;
wherein the spatula comprises metal;
wherein one of the plurality of grill-cleaning attachments includes a wire brush;
wherein one of the plurality of grill-cleaning attachments includes a cleaning pad;
wherein one of the plurality of grill-cleaning attachments includes a fork;
wherein the fork comprises metal;
wherein the fork includes a pair of skewer-prongs;
wherein the handle grip comprises rubber;
wherein the elongated shaft is at least 4 inches in length; and
wherein the device weighs less than 5 lbs.

18. The grill cleaning device of claim 17, further comprising set of instructions; and
wherein the grill cleaning device is arranged as a kit.

19. A method of using a grill cleaning device for use in cleaning a barbecue grill cooking surface, the method comprising the steps of:
providing a grill cleaning device including an elongated shaft having a proximate end and a distal end, the elongated shaft including a handle grip located at the proximate end and a female clip portion located at the distal end and a plurality of grill-cleaning attachments, each of the plurality of grill-cleaning attachments including a working surface and a male clip portion configured to mechanically couple with the female clip portion of the elongated shaft;
selecting one of the plurality of grill-cleaning attachments for use;
coupling the male clip portion of one of the plurality of grill-cleaning attachments into the female clip portion of the elongated shaft; and
cleaning the barbecue grill cooking surface.

20. The method of claim 19, further comprising the steps of:
uncoupling the male clip portion of one of the plurality of grill-cleaning attachments from the female clip portion of the elongated shaft; and
washing the plurality of grill-cleaning attachments.
